(19) United States
(12) Patent Application Publication
(10) Pub. No.: US 2022/0398764 A1
(43) Pub. Date: Dec. 15, 2022

(54) SPATIAL TEMPERATURE ESTIMATION SYSTEM, WARM/COLD SENSATION ESTIMATION SYSTEM, SPATIAL TEMPERATURE ESTIMATION METHOD, WARM/COLD SENSATION ESTIMATION METHOD, AND PROGRAM

(71) Applicant: Panasonic Intellectual Property Management Co., Ltd., Osaka (JP)

(72) Inventors: Nobuaki SHIMAMOTO, Fukui (JP); Nayuta MINAMI, Fukui (JP)

(21) Appl. No.: 17/783,529

(22) PCT Filed: Oct. 16, 2020
(86) PCT No.: PCT/JP2020/039188

§ 371 Date: Jun. 8, 2022

(30) Foreign Application Priority Data
Dec. 10, 2019 (JP) 2019-223242

(51) Int. Cl. G06T 7/70; G01J 5/02

(52) U.S. Cl. CPC G06T 7/70; G01J 5/0275; G01J 2005/0077

(57) ABSTRACT

A spatial temperature estimation system includes a thermal image acquisition unit and a space temperature estimation unit. The thermal image acquisition unit is configured to detect a temperature of at least one surface of a ceiling, a floor, or a plurality of walls of a room. The space temperature estimation unit is configured to estimate a temperature of air in an interior space of a room with reference to a CRI coefficient relating to the at least one surface and the temperature detected by the thermal image acquisition unit.

### TECHNICAL FIELD

The present disclosure relates to spatial temperature estimation systems, warm/cold sensation estimation systems, spatial temperature estimation methods, warm/cold sensation estimation methods, and programs. More specifically, the present disclosure relates to a spatial temperature estimation system using a Contribution Ratio of Indoor Climate (CRI) coefficient, a warm/cold sensation estimation system including the spatial temperature estimation system, a spatial temperature estimation method, a warm/cold sensation estimation method, and a program.

### BACKGROUND ART

Patent Literature 1 discloses an air conditioner including a thermal image acquisition unit (thermograph), a computing unit, and a control unit. The thermal image acquisition unit acquires a thermal image representing temperature distribution in a space. The computing unit specifies a region corresponding to a person in the thermal image acquired by the thermal image acquisition unit. The computing unit then determines, based on temperature distribution in the region corresponding to the person in the thermal image, a human body temperature which is a temperature of the person present in the space. The computing unit then estimates, based on a difference value between the human body temperature and ambient temperature obtained from a temperature of a region other than the region corresponding to the person, a warm/cold sensation of the person present in space. The control unit controls, based on the warm/cold sensation estimated by the computing unit, at least one of an air volume, an air temperature, and an airflow direction of the air conditioner.

In the air conditioner disclosed in Patent Literature 1, the temperature obtained from the region other than the region corresponding to the person in the thermal image acquired by the thermal image acquisition unit (thermograph) is defined as the temperature of the space surrounding the person. However, the thermal image represents a temperature(s) of a thermal factor(s) (a wall(s), a ceiling, a floor, etc.) captured in the thermal image but does not necessarily represent the temperature of air in the space captured in the thermal image. The air conditioner disclosed in Patent Literature 1 may not appropriately provide the temperature of the air in the space surrounding the person.

### CITATION LIST

### Patent Literature

Patent Literature 1: WO 2015/122201 A1

### SUMMARY OF INVENTION

It is an object of the present disclosure to provide a spatial temperature estimation system, a warm/cold sensation estimation system, a spatial temperature estimation method, a warm/cold sensation estimation method, and a program which are configured to estimate the temperature of air in an interior space by a simple calculation.

A spatial temperature estimation system of an aspect of the present disclosure includes a temperature detector and a space temperature estimator. The temperature detector is configured to detect a temperature of at least one surface of a ceiling, a floor, or a plurality of walls of a room. The space temperature estimator is configured to estimate a temperature of air in an interior space of the room with reference to a CRI coefficient relating to the at least one surface and the temperature detected by the temperature detector.

A warm/cold sensation estimation system of an aspect of the present disclosure includes the spatial temperature estimation system, a person location detector, and a warm/cold sensation index calculator. The person location detector is configured to detect a location of a person present in the room. The warm/cold sensation index calculator is configured to calculate an index representing a warm/cold sensation of the person with reference to the temperature, estimated by the spatial temperature estimation system, of the air at the location of the person.

A spatial temperature estimation method of an aspect of the present disclosure includes a temperature detection step and a space temperature estimation step. The temperature detection step includes detecting a temperature of at least one surface of a ceiling, a floor, or a plurality of walls of a room. The space temperature estimation step includes estimating a temperature of air in an interior space of the room with reference to a CRI coefficient relating to the at least one surface and the temperature detected by the temperature detector.

A warm/cold sensation estimation method of an aspect of the present disclosure is a warm/cold sensation estimation method using the spatial temperature estimation method. The warm/cold sensation estimation method includes a person location detection step and a warm/cold sensation index calculation step. The person location detection step includes detecting a location of a person present in the room. The warm/cold sensation index calculation step includes calculating an index representing a warm/cold sensation of the person with reference to the temperature, estimated by the spatial temperature estimation method, of the air at the location of the person.

A program of an aspect of the present disclosure is a program configured to cause a computer system to execute the spatial temperature estimation method.

A program of an aspect of the present disclosure is a program configured to cause a computer system to execute the warm/cold sensation estimation method.

### BRIEF DESCRIPTION OF DRAWINGS

FIG. 1 is a block diagram of a warm/cold sensation estimation system according to an embodiment;

FIG. 2 is an illustrative view of a spatial temperature estimation method of a spatial temperature estimation system included in the warm/cold sensation estimation system;

FIG. 3 is an illustrative view of installation locations of an air conditioner in a room;

FIGS. 4A to 4C are illustrative views of compositions of thermal images when the installation locations of the air conditioner are respectively at the “center”, a “left end”, and a “right end”;

FIG. 5 is a flowchart illustrating operation of the warm/cold sensation estimation system;

FIG. 6 is a block diagram of a warm/cold sensation estimation system according to a first variation;

FIGS. 7A to 7C are each a block diagram of a warm/cold sensation estimation system according to the first variation;

FIG. 8 is a block diagram of a warm/cold sensation estimation system according to a second variation;

FIG. 9A is an illustrative view of an example of the thermal image;

FIG. 9B is an illustrative view of an example of a restored image;

FIG. 10 is a block diagram of a warm/cold sensation estimation system according to a third variation;

FIG. 11 is a block diagram of a warm/cold sensation estimation system according to a fourth variation;

FIG. 12 is a block diagram of a warm/cold sensation estimation system according to a fifth variation; and

FIG. 13 is a block diagram of a warm/cold sensation estimation system according to a sixth variation.

### DESCRIPTION OF EMBODIMENTS

### Embodiment

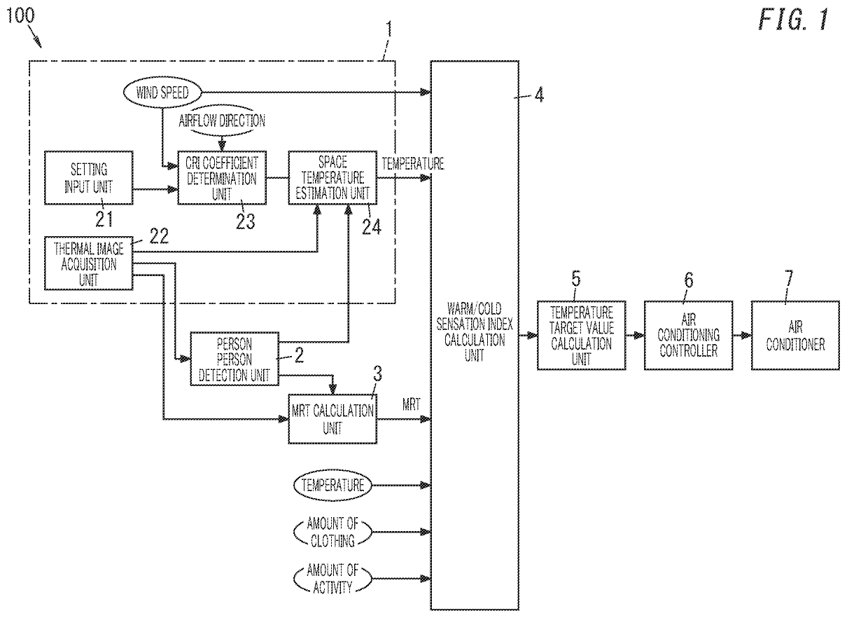

With reference to FIGS. 1 to 5, a spatial temperature estimation system 1 and a warm/cold sensation estimation system 100 according to the present embodiment will be described.

The spatial temperature estimation system 1 (see FIG. 1) is a system configured to estimate temperature distribution in an interior space of a room as a target. The temperature distribution in the interior space means distribution of temperatures of air at locations in the interior space. The warm/cold sensation estimation system 100 (see FIG. 1) is a system configured to estimate a warm/cold sensation of a person present in the room as the target with reference to the temperature distribution, estimated by the spatial temperature estimation system 1, in the interior space. In the present embodiment, the warm/cold sensation estimation system 100 controls, based on the warm/cold sensation thus estimated, an air conditioner configured to control a temperature in the room as the target. Thus, the temperature in the room as the target is automatically controlled to be a temperature at which the person present in the room feels comfortable.

Note that the spatial temperature estimation system 1 and the warm/cold sensation estimation system 100 are disposed outside an air conditioner 7 in the present embodiment but may be disposed inside the air conditioner 7. The room as the target may be a room in a building or may be a room in a movable object such as an automobile (e.g., a bus).

As described above, the spatial temperature estimation system 1 is configured to estimate the temperature distribution in the interior space of the room as the target. More specifically, the spatial temperature estimation system 1 is configured to estimate a temperature of air (air temperature) at each of the locations in the interior space using a Contribution Ratio of Indoor Climate (CRI) coefficient.

A concept of an estimation of the temperature of the air (the air temperature) in the interior space in the present embodiment will now be described. Once the dimension of the room and a flow of air in the room are determined, influence of a flow of air blown out through an outlet (e.g., an air conditioner) on the person present at a given location in the room may be deemed constant. Therefore, an air temperature at the given location in the interior space is calculable by adding up degrees of thermal influence from thermal factors such as wall and floor temperatures of the room under the determined dimension of the room and the determined flow of the air. Such degrees of thermal influence are calculated using CRI coefficients, and thereby, the air temperature at the given location in the interior space is simply calculable (can be simply estimated). Note that the thermal factor is a factor which can be a heat source and is, for example, a ceiling, a floor, or a wall.

That is, airflow distribution in the room is at first determined by a Computational Fluid Dynamics (CFD) analysis, and then, the degrees of thermal influence that the thermal factors contribute to the given location in the room are calculated based on the airflow distribution. Thus, even when the temperature of each of the thermal factors changes, simply adding up the degrees of thermal influence resulting from changes in the temperatures of the thermal factors enables the air temperature at the given location to be calculated.

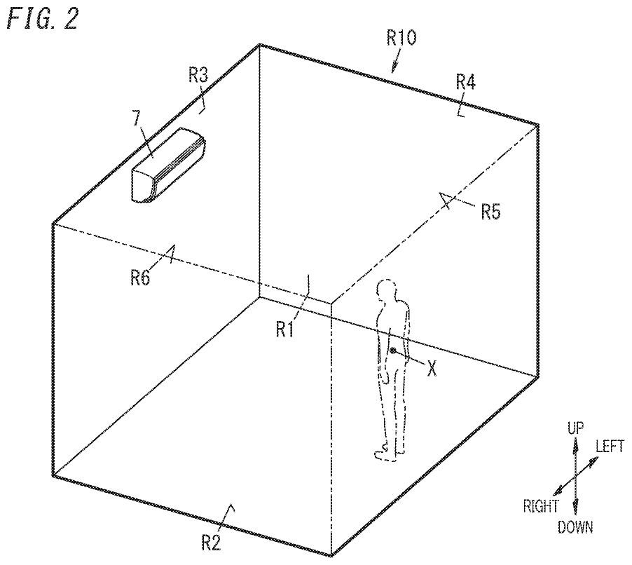

Specifically, the air conditioner 7 is supposed to be installed in a room R10 as shown in FIG. 2. In this case, a temperature θ_{X} at a given location X in the room R10 is calculable using formula 1 and formula 2. Note that in the example shown in FIG. 2, a total of six surfaces of a ceiling R1, a floor R2, and surrounding (e.g., four) walls R3 to R6 of the room R10 are the thermal factors.

θ_{X}=θ_{b}+Δθ_{X} Formula 1

Δθ_{X}=C_{X,1}×θ_{0,1}+C_{X,2}×θ_{0,2}+ . . . +C_{X,6}×θ_{0,6} Formula 2

Here, θ_{b} is a reference temperature at the location X, and in the present embodiment, for example, θ_{b} is set to 0 (zero) degrees Celsius. Δθ_{X} is a changed temperature Δθ_{X} at the location X. That is, the temperature θ_{X} of air at the location X is calculated by addition of the reference temperature θ_{b} at the location X and the changed temperature Δθ_{X} at the location X.

The changed temperature Δθ_{X} at the location X is a temperature resulting from the thermal influence from each thermal factor. The changed temperature Δθ_{X} at the location X is given by formula 2. θ_{0,1} to θ_{0,6} are changed temperatures respectively of the thermal factors (the ceiling R1, the floor R2, and the four walls R3 to R6 of the room R10). C_{X,1} to C_{X,6} are CRI coefficients relating to the respective thermal factors with respect to the location X and represent ratios of thermal contribution of the changed temperatures from the respective thermal factors to the location X. Note that each CRI coefficient relating to a corresponding one of the thermal factors is a value which is determined once the dimension of the room R10 and airflow distribution in the room R10 are determined. The degree of the thermal influence that contributes from the thermal factor to the location X is calculated by multiplication of the changed temperature of the thermal factor and the CRI coefficient relating to the thermal factor. That is, the changed temperature Δθ_{X} at the location X is calculated by addition of the degrees of the thermal influence that contributes from the thermal factors to the location X. The degrees of the thermal influence that contributes from the thermal factors to the location X are calculated by multiplying the changed temperatures θ_{0,1} to θ_{0,6} of the respective thermal factors respectively by the CRI coefficients C_{X,1} to C_{X,6} relating to the respective thermal factors.

The dimension of the room R10 and the installation location of the air conditioner 7 determine the airflow distribution in the room R10, and the dimension of the room R10 and the airflow distribution in the room R10 (airflow distribution of air blown out from the air conditioner 7) determine the CRI coefficients relating to the respective thermal factors. Thus, the changed temperatures θ_{0,1} to θ_{0,6} of the respective thermal factors are measured, and thereby, the changed temperatures θ_{0,1} to θ_{0,6} thus measured of the respective thermal factors and the CRI coefficients relating to the respective thermal factors determine the changed temperature Δθ_{X} at the given location X. From the changed temperature Δθ_{X} and the reference temperature Ob, the temperature at the given location X in the room is obtained.

With reference to FIG. 1, the configuration of the warm/cold sensation estimation system 100 including the spatial temperature estimation system 1 will be described in detail. In the following description, the temperature in the interior space of the room R10 shown in FIG. 2 is assumed to be estimated.

The warm/cold sensation estimation system 100 includes the spatial temperature estimation system 1, a person location detection unit 2, a mean radiant temperature calculation unit 3, a warm/cold sensation index calculation unit 4 (warm/cold sensation index calculator), a temperature target value calculation unit 5, an air conditioning controller 6, and the air conditioner 7. The spatial temperature estimation system 1 includes a setting input unit 21, a thermal image acquisition unit 22 (temperature detector, thermal image acquirer), a CRI coefficient determination unit 23, and a space temperature estimation unit 24 (space temperature estimator). Note that the air conditioner 7 is included in components of the warm/cold sensation estimation system 100 in the present embodiment but does not have to be included in the components of the warm/cold sensation estimation system 100.

The setting input unit 21 receives various types of setting information (dimension information and installation location information) as an operation input given by an operator. The dimension information is information on the dimension of the room R10 as a target. The dimension information is information on, for example, the floor surface shape (e.g., a longitudinally elongated rectangular shape, a laterally elongated rectangular shape, or a square shape) and the floor area of the room R10. Note that the floor area of the room R10 determines the performance of the air conditioner 7, and therefore, information on the air conditioning performance (e.g., rated power consumption) of the air conditioner 7 is, in the present embodiment, automatically set by being acquired from the air conditioner 7. The setting input unit 21 may be installed on a wall of the room R10 and may be configured as a remote control. Moreover, the setting input unit 21 may be used also as a remote control for the air conditioner 7.

The installation location information is information on the installation location of the air conditioner 7 in the room R10. The installation location information is information on the height (height from the floor R2) of the installation location of the air conditioner 7 and a location (the left end, the center, or the right end) in the left/right direction of the wall R3 on which the air conditioner 7 is installed. The height of the installation location of the air conditioner 7 is substantially equal to the height of the room R10, and in the present embodiment, the height of the installation location of the air conditioner 7 is set to a fixed value (e.g., 2.2 m) in advance. In the following description, the dimension of the room R10, the installation location of the air conditioner 7, and the speed and the direction of air blown out from the air conditioner 7 are collectively referred to as a “dimension condition”.

Note that alternatively to an operator giving a setting input of the dimension information and the installation information to the setting input unit 21, the spatial temperature estimation system 1 may automatically estimate the dimension information and the installation information with reference to, for example, a thermal image acquired by the thermal image acquisition unit 22. This variation will be described later.

The CRI coefficient determination unit 23 specifies, based on the dimension information and the installation location information input to the setting input unit 21 and the information on the speed and the direction of air blown out from the air conditioner 7, the dimension condition of the room R10. Then, the CRI coefficient determination unit 23 determines a CRI coefficient corresponding to the dimension condition thus specified.

More specifically, the dimension condition of the room R10 is specified by the dimension information and the installation location information input to the setting input unit 21 and the speed and the direction of air blown out from the air conditioner 7. The dimension information includes information on the floor surface shape (a longitudinally elongated rectangular shape, a laterally elongated rectangular shape, or a square shape) of the room R10. The installation location information includes information on the installation location (the center, the left end, or the right end) of the air conditioner 7. The information on the speed and the direction of air blown out from the air conditioner 7 is acquirable from the air conditioner 7. The present embodiment adopts, as the information on the speed and the direction of air blown out from the air conditioner 7, set values of a typical wind speed and a typical airflow direction set in the CRI coefficient determination unit 23 in advance. The number of dimensions available for the room R10 is, for example, three, namely, a laterally elongated rectangular shape, a longitudinally elongated rectangular shape, and a square shape. The number of installation locations available for the air conditioner 7 is, for example, three, namely, the left end, the right end, and the center. The speed available for air blown out from the air conditioner 7 is, for example, one of set values set in advance. The airflow direction available for air blown out from the air conditioner 7 is, for example, one of set values set in advance. Thus, in the present embodiment, the number of dimension conditions available for the room R10 is, for example, nine (=3×3××1). The CRI coefficient is determined for each dimension condition, and thus, in the present embodiment, for example, there are nine CRI coefficients.

The CRI coefficient determination unit 23 stores a plurality of (in the present embodiment, nine) CRI coefficients in a prescribed storage. The plurality of CRI coefficients correspond to the plurality of dimension conditions available for the room R10 on a one-to-one basis. The CRI coefficient determination unit 23 specifies, based on the dimension information and the installation location information input to the setting input unit 21 and the information on the speed and the direction of air blown out from the air conditioner 7, the dimension condition of the room R10. The CRI coefficient determination unit 23 selects (determines), from the plurality of CRI coefficients, a CRI coefficient corresponding to the dimension condition thus specified.

That is, in the present embodiment, a CRI coefficient corresponding to the dimension condition thus specified is selected (determined) from the plurality of CRI coefficients prepared in advance alternatively to a CRI coefficient being calculated based on the dimension condition thus specified. Thus, process loads for a space temperature estimation of the room R10 can be reduced, and the CRI coefficient can be determined at a further increased speed. Moreover, since the CRI coefficient is changed in accordance with the dimension condition, the temperature of air in the interior space of the room R10 can be estimated with further improved accuracy.

The thermal image acquisition unit 22 acquires (i.e., captures) a thermal image including any one or more of the surfaces (the ceiling R1, the floor R2, and the walls R3 to R6) of the room R10. The thermal image acquisition unit 22 is disposed, for example, in the air conditioner 7 or is disposed in the vicinity of the air conditioner 7. The thermal image is, for example, a temperature distribution image in which the temperature of an object (thermal factor) captured in the thermal image is measured pixel by pixel and the pixels are represented in different colors depending on temperatures in the pixels. From the thermal image, the changed temperatures of the thermal factors (the ceiling R1, the floor R2, and the walls R3 to R6 of the room R10) are measurable. In the present embodiment, an image is acquired which includes, for example, four surfaces (the floor R2 and the three walls R4 to R6 except for the wall R3 on which the air conditioner 7 is installed). The thermal image acquisition unit 22 may be, for example, an infrared array sensor. The infrared array sensor is a sensor including plurality of infrared ray light receiving elements arranged longitudinally and laterally. The thermal image acquisition unit 22 is a temperature detector configured to detect a temperature of any one or more of the surfaces (the ceiling R1, the floor R2, and the walls R3 to R6) of the room R10.

Note that the surfaces (the ceiling R1, the floor R2, and the walls R3 to R6) of the room R10 are oriented in different directions from one another. In the present embodiment, the thermal image acquisition unit 22 acquires a thermal image including four surfaces oriented in different directions from one another. However, the thermal image acquisition unit 22 may acquire a thermal image including three or more surfaces, or two or more surfaces, oriented in different directions from one another. Note that as the number of surfaces included in the thermal image increases, the estimation accuracy of the temperature distribution in the interior space of the room R10 is improved.

The person location detection unit 2 detects, based on the thermal image acquired by the thermal image acquisition unit 22, the location X of a person present in the room R10. More specifically, the person location detection unit 2 specifies, based on a temperature corresponding to a person, the shape of temperature distribution of the temperature corresponding to the person, and the like, a region corresponding to the person in the thermal image, and the person location detector 2 detects, based on the region thus specified, the location X of the person present in the room R10. For example, a prescribed location within a specified region may be used as the location X of the person.

The space temperature estimation unit 24 estimates the temperature of air (air temperature) in the interior space of the room R10. More specifically, the space temperature estimation unit 24 estimates, as the air temperature at the given location X in the interior space of the room R10, an air temperature at the location of the person present in the room R10 with reference to the changed temperatures of the thermal factors (the ceiling R1, the floor R2, and the four walls R3 to R6) of the room R10, a sensing result (i.e., the location of the person present in the room R10) by the person location detection unit 2, and the CRI coefficient determined by the CRI coefficient determination unit 23.

Much more specifically, the space temperature estimation unit 24 detects the changed temperatures of the thermal factors of the room R10 with reference to the thermal image acquired by the thermal image acquisition unit 22. Specifically, the space temperature estimation unit 24 specifies, based on the dimension information, the dimension (the floor area and the floor surface shape) of the room R10. The space temperature estimation unit 24 then specifies, based on the dimension thus specified, a correspondence relationship of the ceiling R1, the floor R2, and the walls R3 to R6 of the room R10 to regions in the thermal image (i.e., regions in which the ceiling R1, the floor R2, and the walls R3 to R6 are captured in the thermal image). That is, since an image scanning direction of the thermal image has been specified, the composition of the thermal image (the regions in which the ceiling R1, the floor R2, and the walls R3 to R6 are captured in the thermal image) can be specified once the dimension of the room R10 is specified.

In the present embodiment, the thermal image includes the floor R2 and the walls R4 to R6 of the room R10 and includes neither the ceiling R1 nor the wall R3. Thus, the changed temperatures of the four surfaces, namely, the floor R2 and the walls R4 to R6 are detected, and the changed temperature of neither the ceiling R1 nor the wall R3 is detected from the thermal image. In this case, the thermal contribution amount from each of the ceiling R1 and the wall R3 is regarded as zero. Note that for the sake of an arithmetic process, the changed temperatures of the ceiling R1 and the wall R3 may be regarded as zero.

The space temperature estimation unit 24 calculates (estimates) the air temperature at the location X of a person present in the room R10 with reference to: the changed temperatures, thus detected, of the thermal factors of the room R10; the location of the person detected by the person location detection unit 2; and the CRI coefficients (CRI coefficients relating to the respective thermal factors of the room R10 at the location X of the person) determined by the CRI coefficient determination unit 23. Specifically, the space temperature estimation unit 24 multiplies the changed temperatures of the respective thermal factors of the room R10 by the CRI coefficients relating to the respective thermal factors at the location X of the person, thereby calculating the degrees of thermal influence of the thermal factors, and the space temperature estimator 24 adds up the degrees of thermal influence thus calculated. As a result, the changed temperature at the location X of the person is calculated. The space temperature estimation unit 24 adds up the reference temperature at the location X of the person and the changed temperature at the location X of the person, thereby calculating (estimating) the air temperature at the location X of the person.

The mean radiant temperature calculation unit 3 calculates a Mean Radiant Temperature (MRT) at the location (i.e., the location of the person detected by the person location detection unit 2) X of the person present in the room R10. The mean radiant temperature is a mean value, represented in temperature indication, of heat (radiant heat) radiated from the thermal factors (the ceiling R1, the floor R2, and the walls R3 to R6) of the room R10. More specifically, the mean radiant temperature calculation unit 3 detects, based on the dimension information and the installation location information input to the setting input unit 21 and the thermal image acquired by the thermal image acquisition unit 22, the changed temperatures of the thermal factors of the room R10 in a manner similar to the case of the space temperature estimation unit 24. The mean radiant temperature calculation unit 3 calculates, based on the changed temperatures, thus detected, of the thermal factors, the mean radiant temperature, resulting from the radiant heat from the thermal factors, at the location X of the person in the room R10.

The warm/cold sensation index calculation unit 4 calculates an index representing the warm/cold sensation of the person (person detected by the person location detection unit 2) present in the room R10. In the present embodiment, the warm/cold sensation index calculation unit 4 calculates, as the index described above, a predicted mean vote (PMV), for example. The PMV is calculated from six warmth factors (i.e., an air temperature, a radiation temperature, relative humidity, wind speed, the amount of clothing that the person is wearing, and the amount of activity) for the person by using a prescribed arithmetic expression. Note that since the prescribed arithmetic expression for calculating the PMV is a well-known arithmetic expression, the description thereof is omitted.

Note that the PMV is, for example, a value within a range of −3≤PMV≤±3. In the case of using the PMV, it can be estimated that the warm/cold sensation of the person corresponds to being comfortable when the PMV thus calculated is within a predetermined range (e.g., greater than or equal to −0.5 and less than or equal to +0.5). Moreover, it can be estimated that when the PMV thus calculated is less than the lower limit value (e.g., −0.5) of the predetermined range, the warm/cold sensation of the person corresponds to being cold. At this time, it can be estimated that the smaller the PMV thus calculated is than the lower limit value of the predetermined range, the higher the level of coldness. Moreover, it can be estimated that when the PMV thus calculated is greater than the upper limit value (e.g., +0.5) of the predetermined range, the warm/cold sensation of the person corresponds to being hot. At this time, it can be estimated that the greater the PMV thus calculated is than the upper limit value (+0.5) of the predetermined range, the higher the level of hotness.

Of the six warmth elements, the air temperature is the air temperature at the location X of the person, and as the air temperature, an estimation result by the space temperature estimation unit 24 is used. The radiation temperature is a radiation temperature from each thermal factor of the room R10 at the location X of the person, and as the radiation temperature, a calculation result by the mean radiant temperature calculation unit 3 is used. The relative humidity is relative humidity in the room R10, and as the relative humidity, a measurement result by a humidity sensor installed in the room R10 is used. The humidity sensor may be, for example, a humidity sensor included in the air conditioner 7. The wind speed is wind speed at the location X of the person, and as the wind speed, the wind speed of air blown out from the air conditioner 7 may be used. Information on the wind speed of air blown out from the air conditioner 7 is acquirable from the air conditioner 7. The wind speed of air blown out from the air conditioner 7 may be a typical wind speed of wind speeds of the air conditioner 7. The amount of clothing is the insulation provided by clothing of the person, and as the amount of clothing, a representative value of the amount of clothing set in the warm/cold sensation index calculation unit 4 in advance is used. The amount of activity (i.e., metabolic rate) is the amount of activity of the person, and as the amount of activity, a representative value of amounts of activity set in the warm/cold sensation index calculation unit 4 in advance is used.

The temperature target value calculation unit 5 calculates, based on a calculation result by the warm/cold sensation index calculation unit 4, the temperature target value of air conditioning by the air conditioner 7. More specifically, when the PMV calculated by the warm/cold sensation index calculation unit 4 is within the predetermined range (e.g., greater than or equal to −0.5 and less than or equal to +0.5), the temperature target value calculation unit 5 maintains (resets) the temperature target value of air conditioning by the air conditioner 7 at (to) a current temperature target value. When the PMV calculated by the warm/cold sensation index calculation unit 4 is greater than the upper limit value (e.g., +0.5) of the predetermined range, the temperature target value calculation unit 5 changes (sets) the temperature target value of air conditioning by the air conditioner 7 such that the greater the PMV is than the current temperature target value, the smaller the temperature target value. When the PMV calculated by the warm/cold sensation index calculation unit 4 is lower than the lower limit value (e.g., −0.5) of the predetermined range, the temperature target value calculation unit 5 changes (sets) the temperature target value of air conditioning by the air conditioner 7 such that the smaller the PMV is than the current temperature target value, the greater the temperature target value.

The air conditioning controller 6 controls, based on the temperature target value set by the temperature target value calculation unit 5, the air conditioner 7. More specifically, the air conditioner 7 controls the temperature of air from the air conditioner 7 such that the air temperature in the room R10 approaches a set temperature set in the air conditioner 7. The air conditioning controller 6 sets the set temperature to the temperature target value set by the temperature target value calculation unit 5 such that the air temperature in the room R10 is controlled to be a temperature at which the person in the room R10 feels comfortable.

The air conditioner 7 controls, as described above, the temperature of air from the air conditioner 7 such that the air temperature in the room R10 approaches the set temperature set in the air conditioner 7. More specifically, the air conditioner 7 includes a temperature sensor configured to detect the air temperature in the room R10 and controls the temperature of air from the air conditioner 7 such that a temperature detected by the temperature sensor approaches the set temperature. Moreover, the air conditioner 7 controls the humidity of air from the air conditioner 7 such that the humidity in the room R10 approaches a set humidity set in the air conditioner 7. More specifically, the air conditioner 7 includes a humidity sensor configured to detect the humidity in the room R10 and controls the humidity of air from the air conditioner 7 such that a humidity detected by the humidity sensor approaches the set humidity.

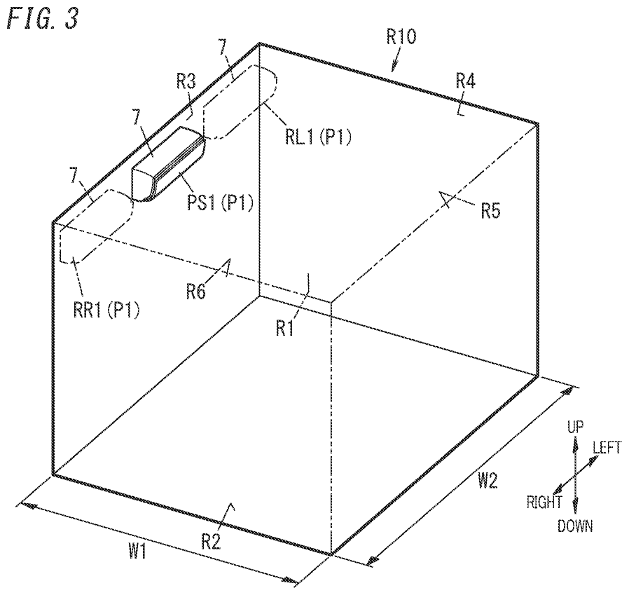

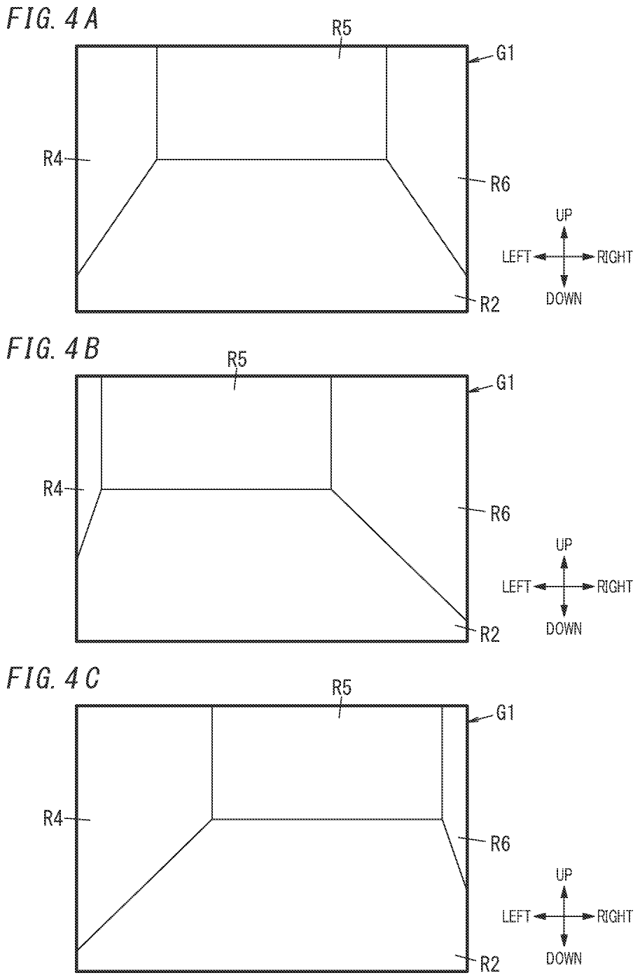

Next, how the composition of the thermal image is specified by the space temperature estimation unit 24 will be supplementarily described with reference to FIGS. 3 and 4.

In the present embodiment, the space temperature estimation unit 24 specifies, based on the installation location information (information on the installation location of the air conditioner 7) input to the setting input unit 21, the composition (captured regions of the ceiling R1, the floor R2, and the walls R3 to R6) of the thermal image acquired by the thermal image acquisition unit 22. Specifically, when an installation location P1 of the air conditioner is the “center” (the center of an upper part of the wall R3) PS1 as shown in FIG. 3, the composition of the thermal image G1 is specified such that the floor R2 and the wall R5 are at the center in the left/right direction in the thermal image G1 as shown in FIG. 4A. Based on the composition thus specified, the space temperature estimation unit 24 detects the change temperatures of the thermal factors (the floor R2 and the walls R4 to R6).

Moreover, when the installation location P1 of the air conditioner 7 is the “right end” (right end of the upper part of the wall R3) RR1 as shown in FIG. 3, the composition of the thermal image G1 is specified such that the floor R2 and the wall R5 are to the left of the center in the left/right direction of the thermal image G1 as shown in FIG. 4B. Based on the composition thus specified, the space temperature estimation unit 24 detects the change temperatures of the thermal factors (the floor R2 and the walls R4 to R6).

Moreover, when the installation location P1 of the air conditioner 7 is the “left end” (left end of the upper part of the wall R3) RL1 as shown in FIG. 3, the composition of the thermal image G1 is specified such that the floor R2 and the wall R5 are to the right of the center of the thermal image G1 as shown in FIG. 4C. Based on the composition thus specified, the space temperature estimation unit 24 detects the change temperatures of the thermal factors (the floor R2 and the walls R4 to R6).

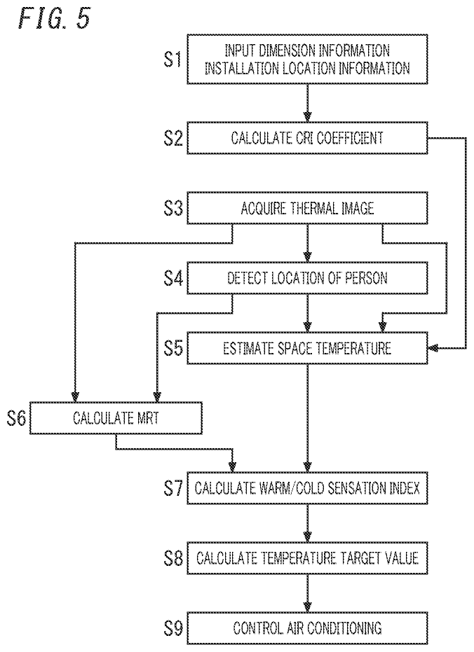

With reference to FIG. 5, operation of the warm/cold sensation estimation system 100 will then be described.

First of all, the dimension information and the installation location information are input to the setting input unit 21 (S1). The CRI coefficient determination unit 23 specifies, based on the dimension information and the installation location information input to the setting input unit 21 and the information, acquired from the air conditioner 7, on the speed and the direction of air blown out from the air conditioner 7, the dimension condition of the room R10. Then, the CRI coefficient determination unit 23 determines, from the plurality of CRI coefficients set in advance, a CRI coefficient corresponding to the dimension condition thus specified (S2).

The thermal image acquisition unit 22 then acquires a thermal image including any one or more surfaces (e.g., four surfaces, namely, the floor R2 and the walls R4 to R6) of the surfaces (the ceiling R1, the floor R2, and the walls R3 to R6) of the room R10 (S3). The person location detection unit 2 then detects, based on the thermal image acquired by the thermal image acquisition unit 22, the location X of a person present in the room R10 (S4).

The space temperature estimation unit 24 then estimates an air temperature at the location X of the person present in the room R10 with reference to the changed temperatures of the thermal factors (the ceiling R1, the floor R2, and the four walls R3 to R4) of the room R10, a sensing result (i.e., the location X of a person present in the room R10) by the person location detection unit 2, and the CRI coefficient determined by the CRI coefficient determination unit 23 (S5).

Note that the “changed temperatures of the thermal factors of the room R10” are detected by the space temperature estimator 24 as follows. That is, the space temperature estimation unit 24 specifies, based on the dimension information and the installation location information input to the setting input unit 21, the composition (captured regions of the ceiling R1, the floor R2, and the walls R3 to R6) of the thermal image acquired by the thermal image acquisition unit 22. From the thermal image with its composition thus specified, the space temperature estimator 24 then detects the changed temperatures of the thermal factors of the room R10. Then, the mean radiant temperature calculation unit 3 calculates, based on the thermal image with its composition thus specified, the mean radiant temperature (MRT) at the location (location detected by the person location detection unit 2) X of the person in the room R10 (S6).

The warm/cold sensation index calculation unit 4 then calculates the PMV as a warm/cold sensation index representing the warm/cold sensation of the person (S7). Here, the PMV is calculated based on: the air temperature, estimated by the space temperature estimation unit 24, at the location X of the person; the mean radiant temperature, calculated by the mean radiant temperature calculation unit 3, at the location X of the person; the wind speed of air blown out from the air conditioner 7; the humidity in the room R10; and the amount of clothing and the amount of activity of the person. The temperature target value calculation unit 5 then calculates, based on the calculation result by the warm/cold sensation index calculation unit 4, the temperature target value of air conditioning by the air conditioner 7 (S8), and the air conditioning controller 6 controls, based on the temperature target value calculated by the temperature target value calculation unit 5, the air conditioner 7 (S9).

As described above, the spatial temperature estimation system 1 of the present embodiment estimates the temperature of air in the interior space of the room R10 with reference to: a temperature of at least one surface of the ceiling R1, the floor R2, or the walls R3 to R6 of the room R10; and the CRI coefficient relating to the at least one surface of the ceiling R1, the floor R2, or the walls R3 to R6. Thus, even when the temperature of each of the thermal factors (the ceiling R1, the floor R2, and the walls R3 to R6) changes, the temperature of air in the interior space of the room R10 can be estimated by simply adding up (i.e., by a simple calculation of) influence by changes in the temperatures (the thermal contribution amounts) of the thermal factors.

Moreover, in the warm/cold sensation estimation system 100 according to the present embodiment, the warm/cold sensation of the person present in the room R10 can be estimated with further improved accuracy by using the spatial temperature estimation system 1.

(Variations)

The variations to be described below may be adopted in combination as appropriate. Moreover, a function similar to the spatial temperature estimation system 1 may be implemented by a spatial temperature estimation method or a computer program. Further, a function similar to the warm/cold sensation estimation system 100 may be implemented by a warm/cold sensation estimation method or a computer program.

A spatial temperature estimation method according to an aspect includes a detection step and a space temperature estimation step. The detection step includes detecting a temperature of at least one surface of the ceiling, the floor R2, or the walls R3 to R6 of the room R10. The space temperature estimation step includes a CRI coefficient relating to the at least one surface and includes estimating the air temperature in the interior space of the room R10 with reference to the temperature detected in the detection step and the CRI coefficient.

A warm/cold sensation estimation method according to an aspect is a warm/cold sensation estimation method using the spatial temperature estimation method. The warm/cold sensation estimation method includes a person location detection step and a warm/cold sensation estimation step. The person location detection step includes detecting the location X of the person present in the room R10. The warm/cold sensation estimation step includes calculating an index representing a warm/cold sensation of the person with reference to the temperature, estimated by the spatial temperature estimation method, of the air at the location X of the person.

A computer program according to an aspect is a program configured to cause a computer system to execute the spatial temperature estimation method.

A computer program according to an aspect is a program configured to cause a computer system to execute the warm/cold sensation estimation method.

The following description of variations is focused on differences from the embodiment. Note that in the following description of the variations, components the same as those in the embodiment are denoted by the same reference signs as those in the embodiment, and the description thereof may be omitted.

(First Variation)

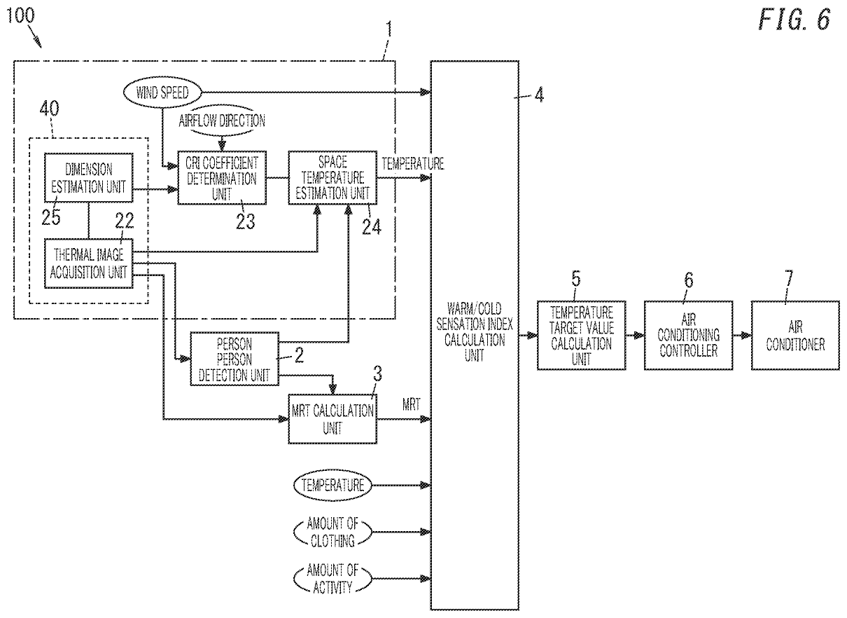

As shown in FIG. 6, the present variation has substantially the same configuration as that described in the embodiment except that the present variation includes a dimension estimation unit 25 in place of the setting input unit 21. The dimension estimation unit 25 estimates the dimension of the room R10 and the installation location of the air conditioner 7 with reference to the thermal image acquired by the thermal image acquisition unit 22. That is, in the present variation, the dimension of the room R10 and the installation location of the air conditioner 7 are not input to the setting input unit 21 by a user but are estimated from the thermal image by the dimension estimation unit 25. Note that the thermal image acquisition unit 22 (temperature detector) and the dimension estimation unit 25 constitute a dimension estimator 40. In the present variation, the thermal image acquisition unit 22 acquires a thermal image including the dimension of the room R10. In the present variation, the thermal image acquisition unit 22 may be an infrared array sensor.

The dimension estimation unit 25 estimates the dimension of the room R10 and the installation location of the air conditioner 7 with reference to a history of locations of the person (person location history) captured in the thermal image. Note that the person location history is a collection of locations of the person which are plotted on the thermal image over a certain time period. The locations of the person in the thermal image are mainly distributed in a region corresponding to the floor R2 in the thermal image and are rarely distributed in regions corresponding to the walls R3 to R6 in the thermal image. By using this characteristic, the dimension of the room R10 and the installation location of the air conditioner 7 can be estimated from the thermal image.

More specifically, the dimension estimation unit 25 detects a region corresponding to the person (i.e., the person) from the thermal image and accumulates the history (person location history) of the locations of the person in the thermal image over a certain time period. The dimension estimation unit 25 estimates, based on the person location history thus accumulated, the dimension of the room R10 and the installation location of the air conditioner 7.

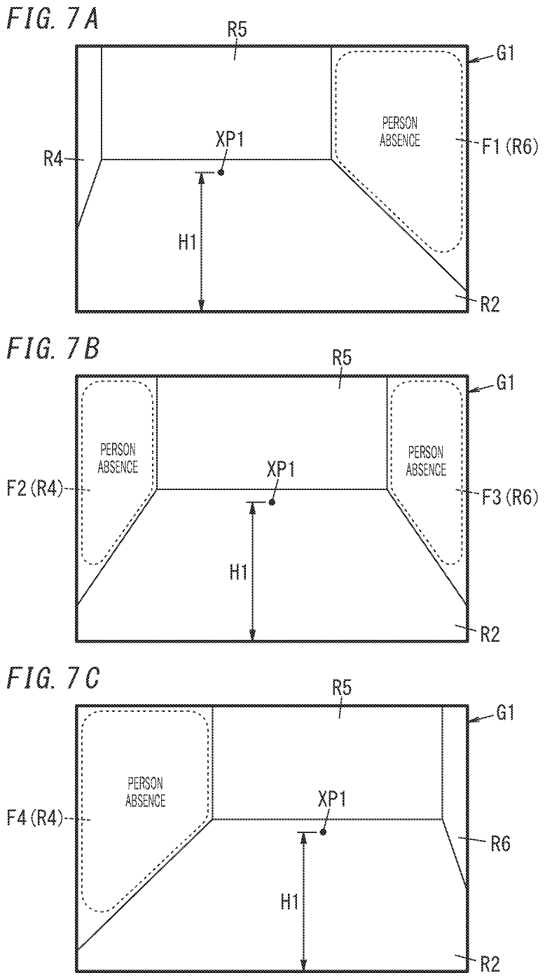

Specifically, the installation location of the air conditioner 7 is estimated as below-described. That is, in the case of the installation location of the air conditioner 7 being the “right end” (the right end of the upper part of the wall R3) PR1 (see FIG. 3), a person absence region F1 in which no person is present occurs at the right side in the thermal image G1 when the person location history is superimposed on the thermal image G1, as shown in FIG. 7A. Thus, when the thermal image G1 has the person absence region F1 at its right side, the dimension estimation unit 25 estimates the region F1 to be the wall R6, and from a location at which the image of the wall R6 is in the thermal image G1, the dimension estimation unit 25 estimates the installation location of the air conditioner 7 to be the “right end”. In the case of the installation location of the air conditioner 7 being the “center” (the center of the upper part of the wall R3) PS1 (see FIG. 3), person absence regions F2 and F3 in which no persons are present occur at the left and right sides in the thermal image G1 when the person location history is superimposed on the thermal image G1, as shown in FIG. 7B. Thus, when the thermal image G1 has the region F2 and the region F3 at its left and right sides, the dimension estimation unit 25 estimates the regions F2 and F3 to be the walls R4 and R6 respectively, and from locations at which the images of the walls R4 and R6 are in the thermal image G1, the dimension estimation unit 25 estimates the installation location of the air conditioner 7 to be the “center”. In the case of the installation location of the air conditioner 7 being the “left end” (the left end of the upper part of the wall R3) PL1 (see FIG. 3), a person absence region F4 in which no person is present occurs at the left side in the thermal image G1 when the person location history is superimposed on the thermal image G1, as shown in FIG. 7C. Thus, when the thermal image G1 has the person absence region F4 at its left side, the dimension estimation unit 25 estimates the region F4 to be the wall R4, and from a location at which the image of the wall R4 is in the thermal image G1, the dimension estimation unit 25 estimates the installation location of the air conditioner 7 to be the “left end”.

Moreover, the dimension of the room R10 is estimated as described below. That is, the dimension estimation unit 25 estimates that in the thermal image G1 on which the person location history is superimposed, the distance H1 between a location XP1 of the person which is the farthest from a lower side of the thermal image G1 in the upward direction and the lower side of the thermal image G1 is the depth W1 (see FIG. 3) of the floor R2 (see FIGS. 7A to 7C). The floor area of the room R10 is, as described in the embodiment, estimated from the air conditioning performance of the air conditioner 7. The dimension estimation unit 25 estimates the lateral width W2 (see FIG. 3) of the room R10 from the floor area and the depth W1 thus estimated, and from the lateral width W2 and the depth W1 thus estimated, the dimension estimation unit 25 estimates the floor shape (a laterally elongated rectangular shape, a longitudinally elongated rectangular shape, or a square shape) of the floor R2 of the room R10.

With this variation, the dimension estimation unit 25 estimates the dimension of the room R10 and the installation location of the air conditioner 7 from the thermal image, and therefore, a user has to input neither the dimension information of the room R10 nor the installation location information of the air conditioner 7.

In the present variation, the space temperature estimation unit 24 changes the CRI coefficient to be used for the space temperature estimation in accordance with the dimension of the room R10 and the installation location of the air conditioner 7 estimated by the dimension estimation unit 25.

(Second Variation)

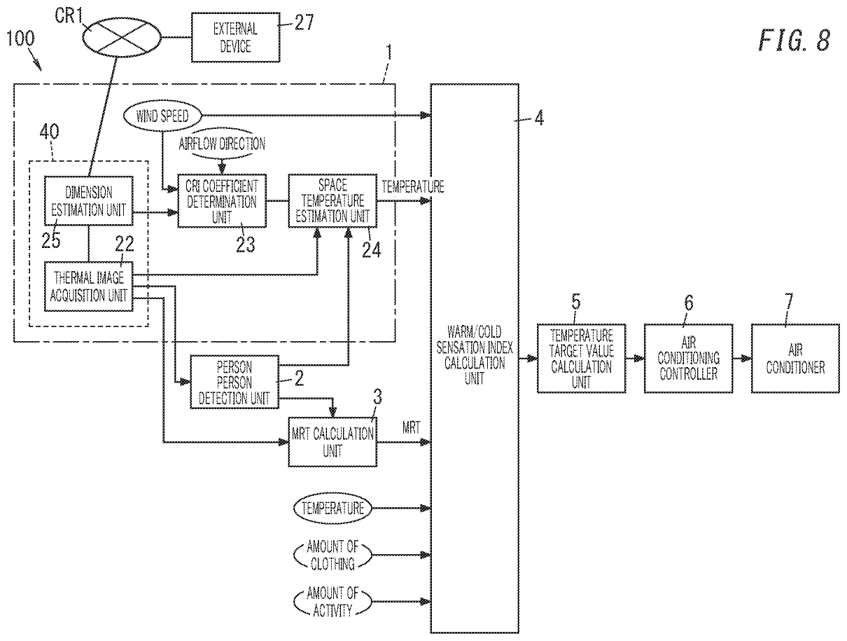

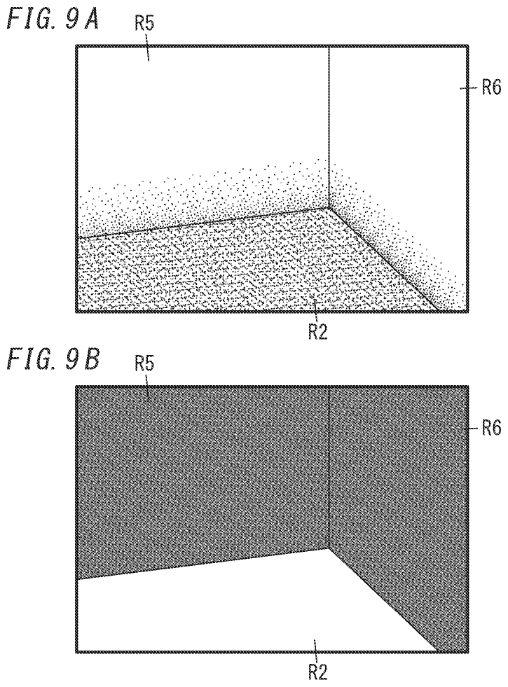

In the first variation, the processes of estimating the dimension of the room R10 and the installation location of the air conditioner 7 are all performed in the dimension estimation unit 25 (i.e., in the spatial temperature estimation system 1). However, as shown in FIG. 8, the thermal image G1 may be transmitted from the dimension estimation unit 25 over a communications network CR1 (cloud) to an external device 27, and the external device 27 may restore (increase the resolution of) the thermal image G1 (FIG. 9A), thereby generating a restored image G2 (FIG. 9B). Then, the restored image G2 may be transmitted from the external device 27 to the dimension estimation unit 25, and the dimension estimation unit 25 may estimate, based on the restored image G2, the dimension of the room R10 and the installation location of the air conditioner 7.

In this case, the contour of the floor R2 is clearly visualized in the restored image G2 by the restoration. The dimension estimation unit 25 estimates, for example, based on the contour of the floor R2 in the restored image G2, a border line between the floor R2 and each of the walls R4 to R6, thereby specifying the composition (captured regions of the floor R2 and the walls R4 to R6) of the restored image G2. The dimension estimation unit 25 estimates, from the composition thus specified, the installation location (the right end, the center, or the left end) of the air conditioner 7 and the dimension (a longitudinally elongated rectangular shape, a laterally elongated rectangular shape, or a square shape) of the room R10.

More specifically, the dimension (floor shape) of the room R10 can be estimated as described below. That is, the dimension estimation unit 25 obtains the depth W1 (see FIG. 3) of the room R10 from the composition thus specified and obtains the lateral width W2 (see FIG. 3) of the floor R2 from the floor area and the depth W1 of the floor R2. Then, from the depth W1 and the lateral width W2 thus obtained, the dimension estimation unit 25 obtains the floor shape of the floor R2. Moreover, the installation location of the air conditioner 7 can be estimated as described below. That is, the dimension estimation unit 25 estimates the installation location of the air conditioner 7 in accordance with, for example, a location in the left/right direction of the wall RS (i.e., a wall in front of the air conditioner 7) in the composition thus specified.

With this configuration, the thermal image G1 may be restored by the external device 27, and the dimension estimation unit 25 may estimate the dimension of the room R10 and the installation location of the air conditioner 7 with reference to the restored image G2. Thus, the dimension of the room R10 and the installation location of the air conditioner 7 can be estimated with further improved accuracy.

(Third Variation)

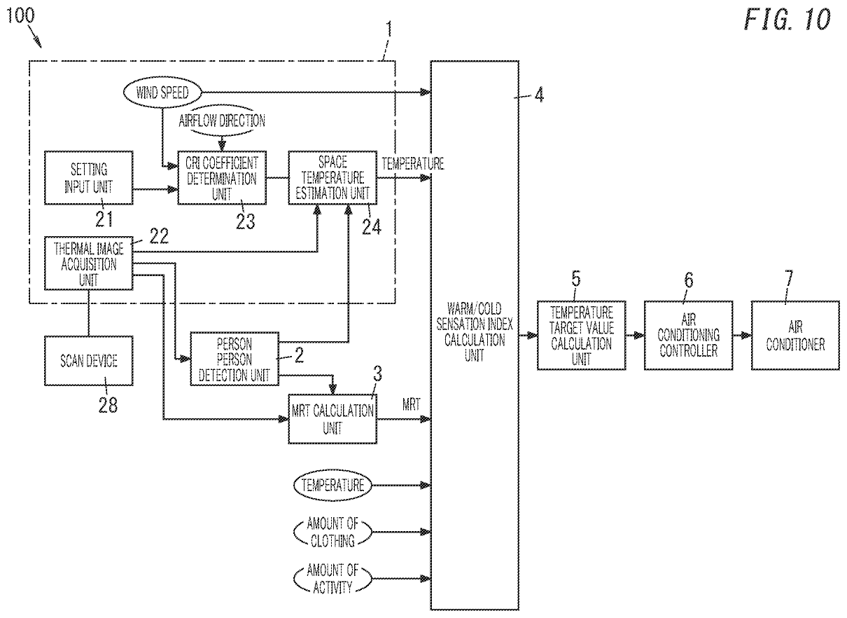

As shown in FIG. 10, a spatial temperature estimation system 1 according to the present variation has substantially the same configuration as that described in the embodiment except that the spatial temperature estimation system 1 according to the present variation further includes a scan device 28 configured to perform scanning in an image capturing direction (detection direction) of the thermal image acquisition unit 22 (temperature detector). The scan device 28 includes a rotary shaft and a rotary drive source (e.g., electric motor). The rotary shaft is rotatable by the rotary drive source. To the rotary shaft, the thermal image acquisition unit 22 is fixed. As the rotary shaft rotates, the thermal image acquisition unit 22 rotates around the rotary shaft, thereby performing scanning in the an image capturing direction (detection direction) of the thermal image acquisition unit 22, for example, in the left/right direction of the room R10. The rotary drive source alternately rotates the rotary shaft in a forward rotation direction and a reverse rotation direction, thereby performing scanning in the image capturing direction of the thermal image acquisition unit 22 in the left/right direction. Thus, an image capturing range (the detection range) of the thermal image acquisition unit 22 can be further extended.

(Fourth Variation)

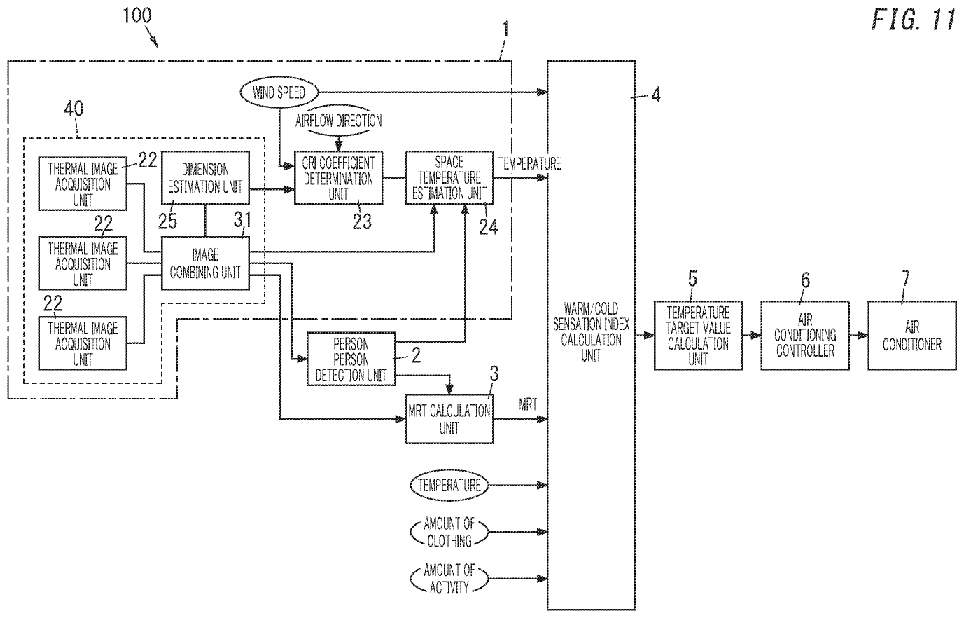

As shown in FIG. 11, the present variation has substantially the same configuration as that described in the first variation except that the present variation includes a plurality of thermal image acquisition units 22 (thermal image acquirers) and further includes an image combining unit 31. The plurality of thermal image acquisition units 22 capture images of different regions (more specifically, different regions of the dimension of the room R10) in the room R10. The image combining unit 31 combines the thermal images acquired by the plurality of thermal image acquisition units 22 to generate a single combined thermal image. The dimension estimation unit 25 of the present variation estimates the dimension of the room R10 and the installation location of the air conditioner 7 with reference to the combined thermal image generated by the image combining unit 31. In the present variation, the plurality of thermal image acquisition units 22, the image combining unit 31, and the dimension estimation unit 25 constitute the dimension estimator 40.

In the present variation, the person location detection unit 2 detects the location X of a person present in the room R10 with reference to the combined thermal image generated by the image combining unit 31. The space temperature estimation unit 24 detects the changed temperatures of the thermal factors of the room R10 with reference to the combined thermal image generated by the image combining unit 31. The mean radiant temperature calculation unit 3 calculates, with reference to the combined thermal image generated by the image combining unit 31, a mean radiant temperature at the location (i.e., location of the person detected by the person location detection unit 2) X of the person present in the room R10.

(Fifth Variation)

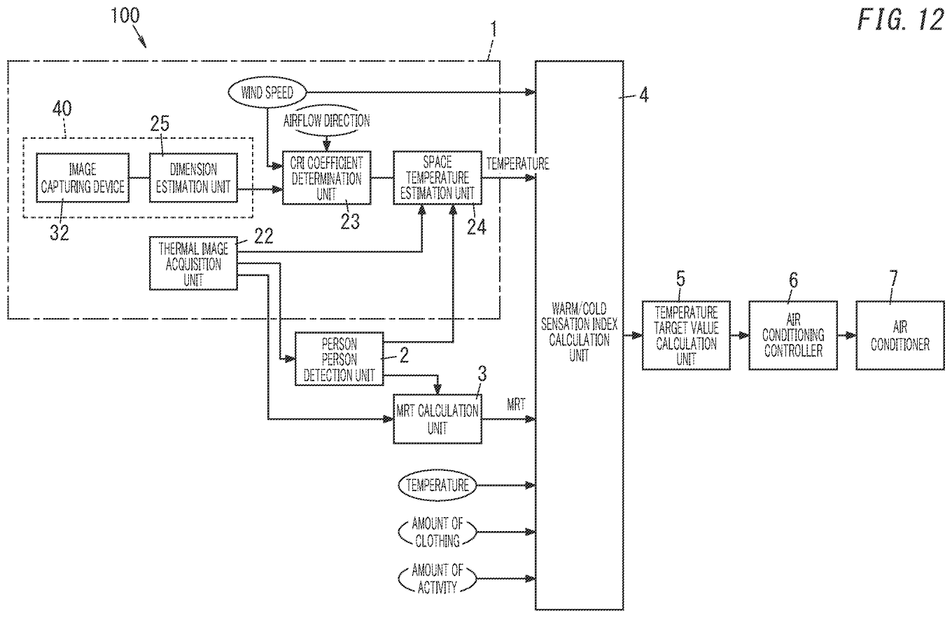

As shown in FIG. 12, the present variation has substantially the same configuration as that described in the first variation except that the present variation further includes an image capturing device 32 configured to acquire a captured image including the dimension of the room R10. The image capturing device 32 is disposed in the air conditioner 7 or is disposed in the vicinity of the air conditioner 7. The dimension estimation unit 25 of the present variation estimates the dimension of the room R10 and the installation location of the air conditioner 7 with reference to the captured image captured by the image capturing device 32 instead of the thermal image acquired by the thermal image acquisition unit 22. In the present variation, the dimension estimator 40 includes the dimension estimation unit 25 and the image capturing device 32.

The image capturing device 32 includes, for example, an imaging element such as a CCD and an imaging lens. In the present variation, the dimension estimation unit 25 binarizes the captured image by the image capturing device 32 to extract the border lines among the ceiling R1, the floor R2, and the walls R3 to R6 of the room R10. The dimension estimation unit 25 specifies, based on the border lines thus extracted, the composition (captured regions of the ceiling R1, the floor R2, and the walls R3 to R6) of the captured image, and estimates, based on the composition thus specified, the dimension of the room R10 and the installation location of the air conditioner 7.

(Sixth Variation)

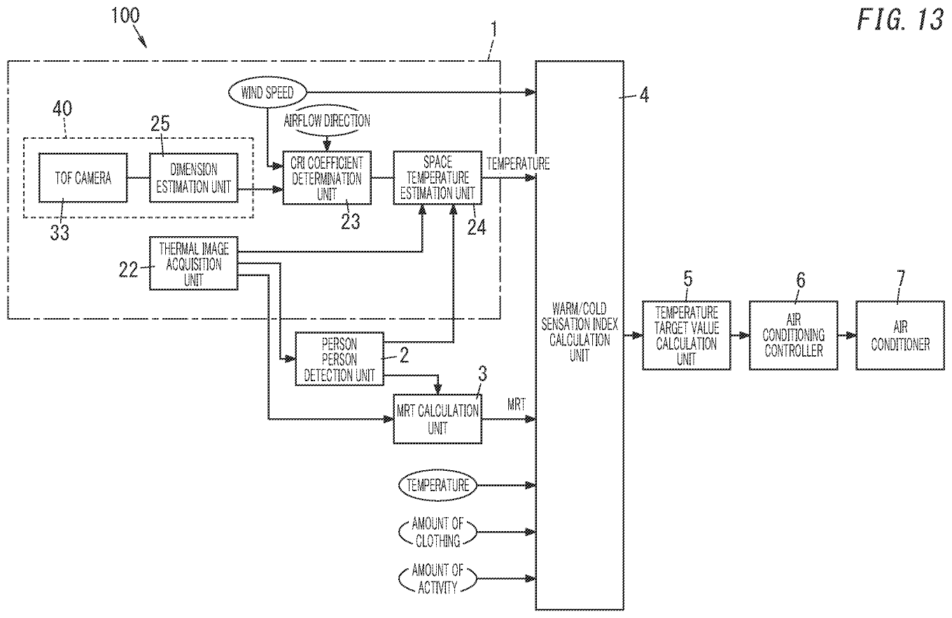

As shown in FIG. 13, the present variation has substantially the same configuration as that described in the fourth variation except that the present variation includes a Time Of Flight (TOF) camera 33 in place of the image capturing device 32. The TOF camera 33 is configured to acquire a distance distribution image including the dimension of the room R10. The TOF camera 33 is disposed in the air conditioner 7 or is disposed in the vicinity of the air conditioner 7. The TOF camera 33 is a camera configured to measure a distance to an object pixel by pixel in accordance with a reflection time of pulse emission light (e.g., near infrared light) from the object and generate an image (distance distribution image) in which the pixels are differently colored depending on their distances. In the present variation, the dimension estimator 40 includes the TOF camera 33 and the dimension estimation unit 25.

In the present variation, the dimension estimation unit 25 extracts border lines among the ceiling R1, the floor R2, and the walls R3 to R6 of the room R10 from the captured image (distance distribution image) by the TOF camera 33. The dimension estimation unit 25 specifies, based on the border lines thus extracted, the composition (captured regions of the ceiling R1, the floor R2, and the walls R3 to R6) of the captured image, and estimates, based on the composition thus specified, the dimension of the room R10 and the installation location of the air conditioner 7.

(Summary)

A spatial temperature estimation system (1) of a first aspect includes a temperature detector (22) and a space temperature estimator (24). The temperature detector (22) is configured to detect a temperature of at least one surface of a ceiling (R1), a floor (R2), or a plurality of walls (R3 to R6) of a room (R10). The space temperature estimator (24) is configured to estimate a temperature of air in an interior space of the room (R10) with reference to a CRI coefficient relating to the at least one surface and the temperature detected by the temperature detector (22).

With this configuration, the temperature of the air in the interior space of the room (R10) is estimated with reference to the temperature of the at least one surface of the ceiling (R1), the floor (R2), or the walls (R3 to R6) of the room (R10) and the CRI coefficient relating to the at least one surface. Thus, even when the temperature of each of thermal factors (the ceiling (R1), the floor (R2), and the walls (R3) to (R6)) changes, the temperature of the air in the interior space of the room (R10) can be estimated by simply adding up (i.e., a simple calculation of) influence by changes in the temperatures of the thermal factors.

In a spatial temperature estimation system (1) of a second aspect referring to the first aspect, the temperature detector (22) is configured to detect temperatures of two or more surfaces of the ceiling (R1), the floor (R2), and the plurality of walls (R4 to R6), the two or more surfaces being oriented in different directions from each other.

With this configuration, the estimation accuracy of the temperature of the air in the interior space of the room (R10) is improved.

In a spatial temperature estimation system (1) of a third aspect referring to the first aspect, the temperature detector (22) is configured to detect temperatures of three or more surfaces of the ceiling (R1), the floor (R2), and the plurality of walls (R4 to R6), the two or more surfaces being oriented in different directions from one another.

With this configuration, the estimation accuracy of the temperature of the air in the interior space of the room (R10) is further improved.

In a spatial temperature estimation system (1) of a fourth aspect referring to any one of the first to third aspects, the space temperature estimator (24) is configured to store a plurality of CRI coefficients corresponding to a plurality of rooms (R10) on a one-to-one basis, the plurality of rooms (R10) having different dimensions from each other.

This configuration enables an optimal CRI coefficient to be used in accordance with the dimension of the room (R10). Consequently, the estimation accuracy of the temperature of the air in the interior space of the room (R10) is further improved.

In a spatial temperature estimation system (1) of a fifth aspect referring to any one of the first to fourth aspects, the temperature detector (22) is an infrared array sensor.

This configuration enables an infrared array sensor to be used as the temperature detector (22).

A spatial temperature estimation system (1) of a sixth aspect referring to the fifth aspect further includes a scan device (28) configured to perform scanning in a detection direction of the temperature detector (22).

This configuration enables scanning to be performed in the detection direction of the temperature detector (22). As a result, the detection range of the temperature detector (22) can be further increased.

A spatial temperature estimation system (1) of a seventh aspect referring to the fourth aspect further includes a dimension estimator (40) configured to estimate a dimension of the room (R10). The space temperature estimator (24) is configured to change the CRI coefficient in accordance with an estimation result by the dimension estimator (40).

With this configuration, the CRI coefficient is changed in accordance with the dimension of the room (R10), and therefore, the temperature of the air in the interior space of the room (R10) is estimated with further improved accuracy. Moreover, the effort of manually inputting dimension information of the room (R10).

In a spatial temperature estimation system (1) of an eighth aspect referring to the seventh aspect, the dimension estimator (40) includes an image capturing device (32) configured to acquire a captured image including the dimension of the room (R10).

With this configuration, the dimension of the room (R10) is estimated with reference to the captured image by the image capturing device (32).

In a spatial temperature estimation system (1) of a ninth aspect referring to the seventh aspect, the dimension estimator (40) includes a TOF camera (33) configured to acquire a distance distribution image including the dimension of the room (R10).

With this configuration, the dimension of the room (R10) is estimated with reference to the distance distribution image acquired by using the TOF camera (33).

In a spatial temperature estimation system (1) of a tenth aspect referring to the seventh aspect, the dimension estimator (40) includes a thermal image acquirer (22) configured to acquire a thermal image including the dimension of the room (R10).

With this configuration, the dimension of the room (R10) is estimated with reference to the thermal image.

In a spatial temperature estimation system (1) of an eleventh aspect referring to the tenth aspect, the dimension estimator (40) includes a plurality of the thermal image acquirer (22). The dimension estimator (40) is configured to combine thermal images acquired by the plurality of thermal image acquirer (22) and estimate, based on the thermal images thus combined, the dimension of the room (R10).

With this configuration, a wide-range thermal image is acquired by the plurality of thermal image acquirer (22).

A warm/cold sensation estimation system (100) of a twelfth aspect includes the spatial temperature estimation system (1) of any one of the first to eleventh aspects, a person location detector (2), and a warm/cold sensation index calculator (4). The person location detector (2) is configured to detect a location (X) of a person present in the room (R10). The warm/cold sensation index calculator (4) is configured to calculate an index (e.g., PMV) representing a warm/cold sensation of the person with reference to the temperature, estimated by the spatial temperature estimation system (1), of air at the location (X) of the person.

With this configuration, the warm/cold sensation of the person present in the room (R10) is estimated by using the spatial temperature estimation system (1).

A warm/cold sensation estimation system of a thirteenth aspect referring to the twelfth aspect further includes a mean radiant temperature calculator (3) configured to calculate a mean radiant temperature at the location (X) of the person present in the room (R10). The warm/cold sensation index calculator (4) is configured to calculate the index (e.g., PMV) with reference to further the mean radiant temperature acquired by the mean radiant temperature calculator (3), the index representing the warm/cold sensation of the person.

With this configuration, the index representing the warm/cold sensation of the person present in the room (R10) is calculated with reference to further the mean radiant temperature at the location of the person in the room (R10), and therefore, the warm/cold sensation of the person in the room (R10) is estimated with further improved accuracy.

A spatial temperature estimation method of a fourteenth aspect includes a temperature detection step, and a space temperature estimation step. The temperature detecting step includes detecting a temperature of at least one surface of a ceiling (R1), a floor (R2), or a plurality of walls (R3 to R6) of a room (R10). The space temperature estimation step includes estimating a temperature of air in an interior space of the room (R10) with reference to a CRI coefficient relating to the at least one surface and the temperature detected by the temperature detector (22).

With this configuration, the temperature of the air in the interior space of the room (R10) is estimated with reference to the temperature of the at least one surface of the ceiling (R1), the floor (R2), or the walls (R3 to R6) of the room (R10) and the CRI coefficient relating to the at least one surface. Thus, even when the temperature of each of thermal factors (the ceiling (R1), the floor (R2), and the walls (R3) to (R6)) changes, the temperature of the air in the interior space of the room (R10) can be estimated by simply adding up (i.e., a simple calculation of) influence by changes in the temperatures of the thermal factors.

A warm/cold sensation estimation method of a fifteenth aspect is a warm/cold sensation estimation method using the spatial temperature estimation method of the fourteenth aspect. The warm/cold sensation estimation method includes a person location detection step and a warm/cold sensation index calculation step. The person location detection step includes detecting a location (X) of a person present in the room (R10). The warm/cold sensation index calculation step includes calculating an index representing a warm/cold sensation of the person with reference to the temperature, estimated by the spatial temperature estimation method, of air at the location (X) of the person.

With this configuration, the index representing the warm/cold sensation of the person present in the room (R10) is calculated by the spatial temperature estimation method.

A program of a sixteenth aspect is a program configured to cause a computer system to execute the spatial temperature estimation method of the fourteenth aspect.

With this configuration, a program configured to cause a computer system to execute the spatial temperature estimation method is provided.

A program of a seventeenth aspect is a program configured to cause a computer system to execute the warm/cold sensation estimation method of the fifteenth aspect.

With this configuration, a program configured to cause a computer system to execute the warm/cold sensation estimation method is provided.

### REFERENCE SIGNS LIST

1 Spatial Temperature Estimation System
3 Mean Radiant Temperature Calculation Unit (Mean Radiant Temperature Calculator)
4 Warm/Cold Sensation Index Calculation Unit (Warm/Cold Sensation Index Calculator)
22 Thermal Image Acquisition Unit (Temperature Detector, Thermal Image Acquirer)
24 Space Temperature Estimation Unit (Space Temperature Estimator)
29 Scan Device
32 Image Capturing Device
33 TOF Camera
40 Dimension Estimator
100 Warm/Cold Sensation Estimation System
R1 Ceiling
R2 Floor
R3 to R6 Walls
R10 Room
X Location of Person

1. A spatial temperature estimation system comprising:
a temperature detector configured to detect a temperature of at least one surface of a ceiling, a floor, or a plurality of walls of a room; and
a space temperature estimator configured to estimate a temperature of air in an interior space of the room with reference to a CRI coefficient relating to the at least one surface and the temperature detected by the temperature detector.

2. The spatial temperature estimation system of claim 1, wherein
the temperature detector is configured to detect temperatures of two or more surfaces of the ceiling, the floor, and the plurality of walls, the two or more surfaces being oriented in different directions from each other.

3. The spatial temperature estimation system of claim 1, wherein
the temperature detector is configured to detect temperatures of three or more surfaces of the ceiling, the floor, and the plurality of walls, the three or more surfaces being oriented in different directions from one another.

4. The spatial temperature estimation system of claim 1, wherein
the space temperature estimator is configured to store a plurality of CRI coefficients corresponding to a plurality of rooms on a one-to-one basis, the plurality of rooms having different dimensions from each other.

5. The spatial temperature estimation system of claim 1, wherein
the temperature detector is an infrared array sensor.

6. The spatial temperature estimation system of claim 5, further comprising a scan device configured to perform scanning in a detection direction of the temperature detector.

7. The spatial temperature estimation system of claim 4, further comprising a dimension estimator configured to estimate a dimension of the room, wherein
the space temperature estimator is configured to change the CRI coefficient in accordance with an estimation result by the dimension estimator.

8. The spatial temperature estimation system of claim 7, wherein
the dimension estimator includes an image capturing device configured to acquire a captured image including the dimension of the room.

9. The spatial temperature estimation system of claim 7, wherein
the dimension estimator includes a TOF camera configured to acquire a distance distribution image including the dimension of the room.

10. The spatial temperature estimation system of claim 7, wherein
the dimension estimator includes a thermal image acquirer configured to acquire a thermal image including the dimension of the room.

11. The spatial temperature estimation system of claim 10, wherein
the dimension estimator includes a plurality of the thermal image acquirers, and
the dimension estimator is configured to
combine thermal images acquired by the plurality of thermal image acquirers and
estimate, based on the thermal images thus combined, the dimension of the room.

12. A warm/cold sensation estimation system comprising:
the spatial temperature estimation system of claim 1;
a person location detector configured to detect a location of a person present in the room; and
a warm/cold sensation index calculator configured to calculate an index representing a warm/cold sensation of the person with reference to the temperature, estimated by the spatial temperature estimation system, of the air at the location of the person.

13. The warm/cold sensation estimation system claim 12, further comprising a mean radiant temperature calculator configured to calculate a mean radiant temperature at the location of the person present in the room, wherein
the warm/cold sensation index calculator is configured to calculate the index with reference to further the mean radiant temperature acquired by the mean radiant temperature calculator, the index representing the warm/cold sensation of the person.

14. A spatial temperature estimation method comprising:
a temperature detecting step of detecting a temperature of at least one surface of a ceiling, a floor, or a plurality of walls of a room; and
a space temperature estimation step of estimating a temperature of air in an interior space of the room with reference to a CRI coefficient relating to the at least one surface and the temperature detected in the temperature detection step.

15. A warm/cold sensation estimation method using the spatial temperature estimation method of claim 14, the warm/cold sensation estimation method comprising:
a person location detection step of detecting a location of a person present in the room; and
a warm/cold sensation index calculation step of calculating an index representing a warm/cold sensation of the person with reference to the temperature, estimated by the spatial temperature estimation method, of air at the location of the person.

16. A non-transitory storage medium storing a program which is configured to cause a computer system to execute the spatial temperature estimation method of claim 14.

17. A non-transitory storage medium storing a program which is program configured to cause a computer system to execute the warm/cold sensation estimation method of claim 15.
